(19) United States
(12) Patent Application Publication
(10) Pub. No.: US 2022/0282560 A1
(43) Pub. Date: Sep. 8, 2022

(54) INDEPENDENTLY OPERATING INSULATED GLASS UNIT ROBOTIC WORK CELL AND METHOD OF MANUFACTURING

(71) Applicant: Erdman Automation Corporation, Princeton, MN (US)

(72) Inventor: Morgan Donohue, North Oaks, MN (US)

(21) Appl. No.: 17/194,403

(22) Filed: Mar. 8, 2021

(51) Int. Cl. E06B 3/677; E06B 3/673

(52) U.S. Cl. CPC E06B 3/6775; E06B 3/67321

(57) ABSTRACT

A robotic work cell to manufacture insulated glass units including a robotic gripper supported by a robot positioned and structured to lift a first glass lite from a first workstation by applying a robotic gripper to a first surface of the first glass lite; a second workstation including a spacer material applicator structured to apply spacer material to a perimeter of the supported first glass lite presented to the second workstation while supported by the robotic gripper; a third workstation reachable by the robot including a second conveyor; and the third workstation further including an edge sealant applicator; wherein the first workstation, the second workstation and the third workstation are within reach of the robotic gripper as manipulated by the robot

### TECHNICAL FIELD

The invention relates generally to the automated assembly of insulated glass units.

### BACKGROUND

Insulated glass generally includes at least two panes of similarly shaped glass, called lites, separated from one another by a perimeter spacer. Building codes in many areas of the country require insulated glass installation as an energy conservation measure, particularly for large commercial properties, because insulated glass units (IGUs) have much greater insulating value than a single pane of glass alone.

A primary sealant binds the two lites to the spacer, preventing ambient air movement into the space between the glass panes. The spacer in an IGU is inset from the peripheral edges, creating a trough-shaped space around the IGU's perimeter. Two sides of the trough are defined by the two lites, and the third is defined by the spacer. A gas such as argon, xenon, or krypton fills the interior space between the lites. Filling the interior space with a gas that is denser than air markedly increases the IGU's energy efficiency and helps prevent condensation from forming on the IGU's interior surfaces. A secondary sealant fills the trough-shaped space around the IGU's perimeter to further improve the IGU's energy efficiency.

In high-volume manufacturing facilities, fully automated equipment commonly applies the spacer and the secondary sealant to the IGU. Fully automated equipment of this sort can manufacture large numbers of identically shaped IGUs. Using automated equipment can therefore help manufacturers reduce costs and increase output; however, the automated manufacturing process requires many different processing units that, occupy substantial physical space and require relatively long periods of time per production run.

FIG. 1 is a process flow diagram representative of automated manufacturing processes typical in the prior art. As shown, nine processing stations are required to produce a single IGU. Typically, these processing stations orient the lites horizontally as they move along the production line. Horizontal orientation helps prevent the large pieces of glass from warping or breaking, but maximizes the amount of floor space occupied by the lites and equipment.

In the example depicted in FIG. 1, the lites are placed on a conveyor or assembly line at an in-feed station. The conveyor then moves each lite into a washer station that cleans both surfaces of the glass. Clean surfaces are important to ensure that the primary and secondary sealants adhere to the glass and because the interior surfaces will be inaccessible once the IGU is complete, making any visible dirt impossible to remove. Accordingly, an inspection station generally follows the washer station to ensure that the panes have been adequately cleaned.

Prior art often refers to the lites as pairs comprising a spacer lite and a wetting or topping lite. The spacer lite is the lite to which the peripheral spacer is applied. The wetting lite is the lite that will be placed across from the spacer lite during the wetting process, generally by positioning the wetting lite on top of the spacer lite. The spacer lite typically requires more processing time and work than the wetting lite, because the spacer must be applied before the wetting process, so the spacer lite is conveyed to each processing station first. A second pane of glass that will become the wetting lite typically follows the first lite in tandem fashion.

In the example depicted in FIG. 1, the first lite is conveyed from the inspection station to the spacer application station. According to some prior art examples, the second lite can be directed along an alternative assembly line after exiting the washer as the first lite is directed along a primary assembly line and mated with the spacer. An example of this is disclosed in U.S. Pat. No. 9,951,553. Primary sealant binds the spacer to the first lite at the spacer application station. Prior art examples disclose fully automated spacer application stations that can apply the primary sealant and the spacer simultaneously.

Typically, the first lite must be queued at an out-feed station while the second lite is prepared for the gas filling and wetting processes. Once the second lite is prepared, the two lites are aligned with one another across the spacer. At the gas filling and wetting station, the cavity between the lites and within the spacer is typically filled with gas before the two lites are pressed together and sealed with the primary sealant. The spacer material is typically pre-coated with the primary sealant, which binds the second lite to the spacer and the first lite via the pressure applied when the lites are pressed together. During the gas filling process, a dense, non-air gas is injected into the cavity, forcing ambient air and moisture out from between the panes. In some examples, like the depicted in FIG. 1, a single, fully automated station can perform both the wetting and the gas filling processes. Other prior art examples require separate processing stations for the wetting and gas filling processes. These insulated glass assembly lines are typically lengthy and may include, for example, up to 15 processing stations totaling a length of approximately 165 feet.

The IGU is typically conveyed next to an out-feed station that can also serve as an inspection station where an employee ensures the two lites are properly bonded together. Then the IGU is conveyed to the secondary sealant application station, where secondary sealant is applied to the trough-shaped space surrounding the IGU's peripheral edges. Finally, the IGU is conveyed to a final out-feed station, from which the IGU may be removed for storage and/or delivery.

Some prior art examples describe processes that adjust the lites from a horizontal orientation to a vertical orientation during the wetting and gas filling processes, reducing the physical space those processing stations occupy. Floor space is a particular concern when manufacturing IGUs for commercial properties, which often use very large panes of glass. Some prior art examples also describe processes that utilize separate assembly lines for the first and second lite, so that the spacer can be applied to the first lite while the second lite is prepared for the gas filling and wetting processes. The first lite and second lite still require different preparation times, however, so these processes still require extra space and production run time to queue at least one of the lites until both pieces of glass are ready to be sealed together. Thus, there is a need in the window manufacturing industry for an insulated glass assembly process that reduces the space, time, and labor of IGU manufacture.

### SUMMARY

An insulated glass unit assembly line, according to example embodiments of the invention, reduces the amount of space, time, and labor required to manufacture IGUs. According to an example embodiment of the invention, the assembly line enables the automated IGU assembly from multiple lites that are aligned across a spacer, bound together with a primary sealant, filled with gas, and peripherally sealed by a secondary sealant. Embodiments of the invention are expected to reduce the manufacturing process's physical space requirements by more than 50% and reduce the manual labor required from approximately five workers to about one half worker required to support operation of the production line. Embodiments of the invention are additionally expected to reduce the cycle time required to load lites and spacer and unload completed insulated glass units, further reducing manufacturing costs. An example embodiment of the assembly line generally includes an automated lite picker, a washer, a vertical gas filling and wetting station, a robot, an applicator station, and an IGU storage rack.

The automated lite picker, according to an example embodiment of the invention, generally includes a ground engaging support, a vertical conveyor, a picker arm, and a lite storage rack. The automated lite picker is typically the first processing unit of the assembly line, and may be oriented such that the vertical conveyor is parallel to the travel axis of the assembly line.

According to another example embodiment of the invention the lite picker may also take the form of a robot, for example, a six axis robot. The application of such a robot enables greater flexibility in the lite loading and placement process. The lite picker robot may be located in front of or behind the lite picker conveyor depending upon a manufacturer's preference as to which side of the completed insulated glass unit the lite with low-E coating is to be located on during the manufacturing process. In the case of the lite picker robot being located behind the lite picker conveyor the lite picker conveyor may include an open portion of the vertical light support that permits the robot to reach through the lite picker conveyor to reach the lites. In this case the robot may include a glass gripper as well as roller beams supported adjacent to the glass gripper.

The ground engaging support, in an example embodiment of the invention, generally comprises parallel beams or rails that stabilize the vertical conveyor. For example, the ground engaging support may comprise two parallel rails that are resting on the ground, parallel to the travel axis of the assembly line, behind the vertical conveyor. In this context, the travel axis of the assembly line is the direction that is parallel to the axis along which the lites generally travel as they move through the assembly line from one processing station to the next processing station. The ground engaging support may also comprise other stabilization structures, including rails that are oriented in other directions, for example, perpendicular to the travel axis of the conveyor.

The vertical conveyor, according to an example embodiment, generally includes a support platform and a conveyor. The vertical conveyor may be mounted, for example, on top of the ground engaging support rails.

The support platform, according to an example embodiment of the invention, generally comprises support frames mounted to the ground engaging support above the conveyor. According to an example embodiment of the invention, the support frames comprise two co-planar rectangular structures separated by a gap through which the extension arm assembly of the picker arm can extend and retract perpendicularly to the conveyor. The support platform may hold the lites in a substantially vertical orientation as the lites are conveyed along the assembly line by the conveyor. Substantially vertical, in this context, means that the lites are held at an orientation that is less than about 25 degrees of true vertical. More typically, the lites are held within 6 to 10 degrees of true vertical, for example, at 6 degrees of true vertical.

According to an example embodiment of the invention, the support platform further includes roller beams coupled to the support frames such that the gap between the support frames is maintained. The roller beams generally comprise multiple parallel rows of passive wheels or rollers over which the lite safely travels under the impetus of the conveyor. For example, the roller beams may be comprised of caster wheels or ball bearings.

The conveyor, according to an example embodiment of the invention, generally moves the lites, in tandem fashion, along the travel axis of the assembly line. According to an example embodiment of the invention, the conveyor can extend along the bottom edge of the support platform.

The picker arm, according to an example embodiment of the invention, generally comprises a picker arm vertical support column and an extension arm assembly.

The picker arm vertical support column, according to an example embodiment of the invention, generally includes a vertical column perpendicularly mounted on the ground engaging support. For example, the picker arm vertical support column may be located on the opposite side of the support platform from the conveyor. Alternatively, the picker arm vertical support column may rest on the ground, suspended from an overhead support, such as tracks, rest on a platform, or otherwise not mounted on the ground engaging support. The extension arm assembly, according to an example embodiment of the invention, generally includes an extension arm track, an extension arm slide, and a glass-gripper head.

The extension arm track, according to an example embodiment of the invention, generally comprises a track that is perpendicularly coupled to the picker arm vertical support column and that operates in a similar fashion to the stabilized track portion of a drawer. For example, the extension arm track may be coupled to the picker arm vertical support column above the ground engaging support and aligned with the gap between the support frames. In one embodiment of the invention, the extension arm track may be fixedly coupled to the picker arm vertical support column. In alternative embodiments, the extension arm track may include a vertically modifiable coupling to the picker arm vertical support column, permitting adjustment of the extension arm track's height to accommodate the manufacture of different sizes and/or shapes of IGUs.

The extension arm slide, according to an example embodiment of the invention, generally comprises a slide inserted into the extension arm track that operates in a similar fashion to the movable slide portion of a drawer. In an example embodiment of the invention, the extension arm slide can extend and retract along the extension arm track, perpendicular to and above the conveyor, between the support frames of the support platform.

The glass-gripper head, according to an example embodiment of the invention, is attached to the extension arm slide such that the glass-gripper head can reach the lite storage rack when the extension arm assembly is extended. The glass-gripper head is capable of gripping the lite and supporting the lite's weight as the picker arm transports the lite from the lite storage rack to the vertical conveyor. For example, the glass-gripper head may utilize a plurality of suction grippers to grip a lite as the extension arm assembly retracts from the lite storage rack to the vertical conveyor. Additionally, when the extension arm assembly is fully retracted the glass-gripper head may release the grip on the lite, and then rest in a position that is out of the direct path of the movement of the lite along the assembly line. For example, the glass-gripper head may have a resting position that is slightly behind the support platform.

The lite storage rack, according to an example embodiment of the invention, stores the lites in a substantially vertical orientation before they are placed on the vertical conveyor. In an example embodiment of the invention, the lite storage rack is situated approximately parallel to and in front of the travel axis of the conveyor, such that the stored lites are facing the assembly line and may be reached by the picker arm when it is extended.

In alternative embodiments, the assembly line may include multiple automated lite pickers and lite storage racks. For example, the assembly line may include a first automated lite picker and a second automated lite picker. Both the first automated lite picker and the second automated lite picker may have a substantially similar structure to the automated lite picker previously described. Generally, using two automated lite pickers and two lite storage racks permits the assembly line to manufacture IGUs from lites that have been pre-treated with a coating. Additional automated lite pickers and lite storage racks may also be included, for example to facilitate manufacture of IGUs from more than two lites.

The lites may comprise glass panes that have been pre-treated in some way, such as with a low emissivity coating like a silver-based film. Low emissivity coatings are generally added to lites to facilitate the IGU's thermal efficiency. According to an example embodiment, the first automated lite picker may be paired with a first lite storage rack having lites oriented such that the coating is on the back side of the lite. Back side, in this context, means that the coating is on the side of the lite that is facing the vertical conveyor. The second automated lite picker, according to this example embodiment, may be paired with a second lite storage rack that has the lites oriented such that the coating is on the front side of the lite. Front side, in this context, means that the coating is on the side of the lite that is facing away from the vertical conveyor.

In an embodiment comprising a robot lite picker, the robot lite picker may be located either in front of or behind the conveyor. In the event that the robot lite picker is utilized, two lite storage racks may be located perpendicular to one another or in another relative orientation within reach of the robot. One lite storage rack contains and stores lites for application on the front of the insulated glass unit while the second lite storage rack contains and stores lites for use on the back of the insulated glass unit. The robot lite picker may include a glass gripper that includes both glass gripping cups and roller assemblies that can be placed in alignment with roller assemblies of the vertical glass support as lites are transported by conveyor into the washer. The glass gripping cups apply sufficient gripping force to lift and manipulate glass panes of the maximum size that the line is designed to handle.

The washer, according to an example embodiment of the invention, is generally conventional and cleans the lites. According to an example embodiment of the invention, the washer cleans the lites one at a time as they are conveyed in tandem fashion along the assembly line.

The vertical gas filling and wetting station, according to an example embodiment, generally comprises a vertical conveyor and a gas fill enclosure.

The vertical conveyor, according to an example embodiment, generally includes vertical support and a conveyor. The vertical support, according to an example embodiment of the invention, is generally a rear wall with an in-feed side and an out-feed side that supports a lite that is being held in a substantially vertical orientation.

The vertical support, according to an example embodiment of the invention, generally includes an in-feed side, a rear wall, and an out-feed side, and permits a lite to be held at a substantially vertical orientation.

The rear wall, according to an example embodiment of the invention, is generally co-planar with the support platform. For example, the rear wall may be situated slightly above the conveyor to support a substantially vertical lite as it moves along the conveyor. The in-feed side, according to an example embodiment of the invention, is on the side of the rear wall that is adjacent to the washer. The out-feed side, according to an example embodiment of the invention, is generally on the opposite edge of the rear wall from the in-feed side.

The conveyor, according to an example embodiment of the invention, is parallel to the ground and generally aligned with the conveyor of the automated lite picker. For example, the conveyor may extend from the in-feed side to the out-feed side of the vertical support, along the bottom edge of the rear wall.

The gas fill enclosure, according to an example embodiment of the invention, generally comprises a movable door, a terminal door, and a gas source. The gas fill enclosure generally creates a 5-sided enclosure that permits air to escape from the unobstructed sixth side as dense gas fills the space between the two lites. For example, the movable door and the terminal door may comprise two sides of the 5-sided enclosure, a first lite and a second lite may comprise two sides of the 5-sided enclosure, and the bottom spacer near the conveyor may form the bottom of the 5-sided enclosure, and air or gas may escape from the unobstructed top side.

The movable door, according to an example embodiment of the invention, generally comprises a movable panel proximate the in-feed side of the vertical support that is shiftable between at least a gas-filling position and a resting position. The gas-filling position may generally be defined by the movable door abutting one edge of the lite, in the direct path of conveyance along the assembly line. For example, the gas-filling position of the movable door may be near the in-feed side of the rear wall with the movable door in a generally vertical orientation. The resting position may generally be defined by the movable door being located out of the direct path of conveyance along the assembly line, apart from the edge of a lite. For example, the resting position of the movable door may be in a generally vertical orientation to either side of the conveyor, or in a generally horizontal orientation co-planar with the conveyor.

The terminal door, according to an example embodiment of the invention, may generally be situated opposite the movable door on the gas fill enclosure at a distance sufficient to accommodate the presence of lites between the terminal door and the movable door. For example, the terminal door may comprise a vertical member perpendicularly coupled to the end of the conveyor at the out-feed side of the rear wall. In an example embodiment of the invention, the terminal door may be fixed in position.

According to an alternative embodiment of the invention, the movable and the terminal door may each be movable or otherwise adjustable, to facilitate the manufacture of different IGU sizes and shapes. For example, both doors may have a gas-filling position, located proximate opposing edges of the 5-sided enclosure defined by two lites, and a resting position, located near opposing outer edges of the gas fill enclosure. In operation, each door may move from the outer edges of the gas-fill enclosure to abut corresponding edges of the lites as the gas is injected into the enclosure. After the gas-filling process is complete, each door in this example embodiment may then return to the respective resting position.

The gas source, according to an example embodiment of the invention, generally includes a plurality of nozzles or ports configured to inject a filling gas into the spacer-created cavity between two lites prior to complete mating of the two lites with the spacer. In an example embodiment of the invention, the gas source may be situated within at least one of the movable door and the terminal door. For example, the gas source may include a plurality of nozzles or ports in operable fluid communication with the supply of the filling gas under pressure. Appropriate valves and controls as known to those skilled in the art are also included. The filling gas may comprise a gas that is denser than air, for example sulfur hexafluoride or a noble gas such as argon.

The spacer application robot, according to an example embodiment, generally comprises a robot support track, a robot base support platform, and an articulated robot arm.

The robot support track, according to an example embodiment of the invention, generally comprises support beams that are perpendicularly coupled to and co-planar with the applicator track, extending away from the assembly line. For example, the robot support track may be perpendicularly coupled to the side of the applicator track that is opposite the vertical gas filling and wetting station. In one embodiment of the invention, the robot support track may comprise two parallel beams that are resting on the ground. Alternatively, the robot support track may be suspended from an overhead support, such as tracks, resting on a platform, or otherwise not resting on the ground.

The robot base support platform, according to an example embodiment of the invention, may be movably coupled to the robot support track opposite the perpendicular applicator track coupling, enabling the robot to move along the robot support track.

The articulated robot arm assembly, according to an example embodiment of the invention, may include a movable robot arm and a glass-gripper end. According to an example embodiment of the invention, the articulated robot arm assembly may be mounted on the robot base support platform.

The movable robot arm, according to an example embodiment of the invention, is structured so the glass-gripper end can reach the gas filling and wetting station as well as the IGU storage rack. For example, the glass-gripper end may grip the front side of a first lite as the articulated robot arm assembly aligns the first lite with the applicator track application of the spacer to the back side of the first lite. The glass-gripper end may also support the first lite and the attached spacer during the gas filling and wetting process, while the primary sealant on the spacer binds the first lite to a second lite, forming an IGU. The articulated robot arm assembly may additionally align the IGU with the applicator track during the application of the secondary sealant to the trough-shaped space along the IGU's peripheral edges. The articulated robot arm may also place the IGU on the IGU storage rack.

It is notable that work is done on the opposite side of the glass lite than in conventional assembly lines. The articulated robot arm assembly grips the glass lite on the front, or outward facing side, of the lite. The articulated robot arm assembly then supports and holds the lite in position while spacer is applied to the back, or inward facing side, of the lite. In this way, multiple steps can be done at one processing location thus saving considerable space and labor in the insulated glass unit manufacturing process. In this context, back or inward side means the side of the lite that faces toward the vertical conveyor and away from the robot.

In an alternative embodiment of the invention, the assembly line may include multiple robots. For example, the assembly line may include a first robot and a second robot. The second robot, according to this embodiment of the invention, may be substantially similar in structure to the first robot, and may be placed following the first robot. According to this embodiment, the first robot supports the lite as the spacer is applied, then places it back on the conveyor, and the second robot supports the IGU as the secondary sealant is applied, then places the IGU on the IGU storage rack.

The applicator station, according to an example embodiment of the invention, generally comprises an applicator track, a spacer applicator, and a secondary sealant applicator.

The applicator track, according to an example embodiment of the invention, generally comprises horizontal rails with a first end and a second end. The first end and second end, according to an example embodiment of the invention, are generally the resting locations of the spacer and secondary sealant applicators.

The horizontal rails, according to an example embodiment of the invention, are generally parallel to the travel axis of the assembly line and perpendicularly coupled with the robot support track. For example, the horizontal rails may comprise two parallel rails situated between the assembly line and the robot. For example, the horizontal rails may be resting on the ground a short distance in front of the vertical gas filling and wetting station. Alternatively, the horizontal rails may be suspended on tracks from an overhead support.

The spacer applicator, according to an example embodiment of the invention, generally comprises a spacer applicator base, a spacer applicator support column, a spacer applicator vertical traveler, a spacer applicator head, and a spacer storage unit.

The spacer applicator base, according to an example embodiment of the invention, is generally movably coupled to one of the first end and the second end of the applicator track, with a resting position opposite the secondary sealant applicator resting position. For example, the spacer applicator track may have a resting position at the first end, and the secondary sealant applicator may have a resting position at the second end. Alternatively, the resting positions of the spacer applicator and the secondary sealant applicator could be switched. Additionally, the movable coupling of the spacer applicator base permits the spacer applicator to travel along the applicator track to an appropriate working position to apply the spacer to the lite that is held by the robot.

The spacer applicator support column, according to an example embodiment of the invention, is generally perpendicularly mounted on the spacer applicator base. In one embodiment of the invention, the spacer applicator support column may be fixedly mounted to the spacer applicator base. Alternatively, the spacer applicator support column may be rotatably and/or pivotably mounted on the spacer applicator base so the spacer applicator support column may be adjusted to facilitate the manufacture of differently sized or shaped IGUs.

The spacer applicator vertical traveler, according to an example embodiment of the invention, is movably coupled to the spacer applicator support column and may travel vertically along the spacer applicator support column.

The spacer applicator head, according to an example embodiment of the invention, is generally rotatably coupled to the spacer applicator vertical traveler, such that the spacer applicator head may apply the spacer to the back side of a lite. Back side, in this context, means the side of the lite that faces toward the vertical conveyor and away from the robot. According to an example embodiment of the invention, the rotatable coupling permits the spacer applicator head to rotate around the corners of the lite.

The spacer storage unit, according to an example embodiment of the invention, generally comprises a flexible spacer applicator head coupling, a spacer supply conduit, and stored spacer material.

The flexible spacer applicator head coupling may generally be flexibly coupled to the spacer applicator head and the spacer supply conduit. The spacer supply conduit, according to an example embodiment of the invention, holds the stored spacer material and supplies it to the spacer applicator head through the flexible spacer applicator head coupling. For example, the spacer storage unit may keep the stored spacer material in a large spool that unwinds at a rate consistent with the rate at which the spacer applicator head applies the spacer to the lite.

The secondary sealant applicator, according to an example embodiment, generally comprises a secondary sealant applicator base, a secondary sealant support column, a secondary sealant vertical traveler, and a secondary sealant applicator head.

The secondary sealant applicator base, according to an example embodiment of the invention, is generally movably coupled to the opposing end of the applicator track from the spacer applicator resting position.

The secondary sealant applicator support column, according to an example embodiment of the invention, is generally perpendicularly mounted on the secondary sealant applicator base. In one embodiment of the invention, the spacer applicator support column may be fixedly mounted to the secondary sealant applicator base. Alternatively, the secondary sealant applicator support column may be movably mounted to the secondary sealant applicator base, to permit the secondary sealant applicator support column to rotate or pivot with respect to the secondary sealant applicator base, facilitating the manufacture of differently sized and shaped IGUs.

The secondary sealant applicator vertical traveler, according to an example embodiment of the invention, is generally movably coupled to the secondary sealant applicator support column, such that the secondary sealant applicator vertical traveler may travel vertically along the secondary sealant applicator support column.

The secondary sealant applicator head, according to an example embodiment of the invention, is generally rotatably coupled to the proximal end of the secondary sealant vertical traveler, permitting the secondary sealant applicator head to pivot around the corners of an IGU as the secondary sealant applicator head applies the secondary sealant to the trough-shaped space along the peripheral edges of the IGU.

According to example embodiments of the invention, having the robot hold and support the insulated glass unit during secondary sealing reduces the need to support the glass from the bottom thereby minimizing the possibility of contamination of the insulated glass unit or the secondary sealant applied as well as reducing labor in the manufacturing process.

The IGU storage rack, according to an example embodiment of the invention, is generally situated on the opposite side of the robot from the applicator station. According to an example embodiment of the invention, the IGU storage rack permits the assembled IGUs to be stored in a substantially vertical orientation. According to one embodiment of the invention, the assembly line may include a first IGU storage rack and a second IGU storage rack. The use of two IGU storage racks, for example, increases the number of IGUs that can be manufactured in each production run because the robot can begin placing IGUs on the second IGU storage rack once the first IGU storage rack is full, without waiting for the first IGU storage rack to be replaced or emptied.

In operation, the assembly line enables automated manufacture of IGUs in a substantially vertical orientation while reducing the space, time, and employees required for production. For example, the first automated lite picker transfers a first lite from the first lite storage rack to the vertical conveyor. The conveyor then moves the first lite to the washer, and as the first lite is cleaned as a second lite may be transferred to the vertical conveyor. For example, the second automated picker may transfer the second lite to the vertical conveyor from the second lite storage rack. Alternatively, the assembly line may only include the first automated lite picker, which transfers both the first and the second lite to the conveyor.

Further alternatively, the assembly line may include a robotic glass lite picker as discussed above. In this case, the robotic glass lite picker lifts both the first glass lite and the second glass lite and places them on the conveyor for passage through the washer. The first glass lite is placed first followed by the second glass lite. Depending upon the desires of the manufacturer a glass lite with low-E glass can be placed first or second so that the low-E glass is on the front or back side of the completed insulated glass unit at the end of the manufacturing process.

Once the first lite is cleaned, the conveyor moves the first lite out of the washer to the vertical gas filling and wetting station. For example, the first lite may exit the washer simultaneously as the second lite enters the washer. The first robot then uses the glass-gripper head to align the first lite with the applicator track. The spacer applicator then moves into an appropriate working position from the spacer applicator resting position and applies the spacer sequentially along each edge of the back side of the first lite.

After the spacer has been applied to the back side of the first lite and the washer has cleaned the second lite, the first robot may move the first lite toward the second lite, so that the gas filling process may be completed as the two lites and the spacer are assembled into an IGU. The robot aligns the bottom edges of the first lite and the second lite with the conveyor to form three sides of the 5-sided enclosure. A leading vertical edge of the lites may be aligned with the terminal door of the gas fill enclosure, opposite a trailing vertical edge of the lites that may be aligned with the gas-filling position of the movable door, to complete the 5-sided enclosure.

Next, the gas source injects a non-air gas into the space between the lites, for example to displace any moisture or air before the two lites are sealed together. After the gas filling process is complete, the first robot presses the two lites together. An adhesive on the spacer seals the back side of the first lite to the front side of the second lite, forming an IGU. The first robot may then align the IGU with the applicator track, so that the secondary sealant applicator can seal the peripheral edges of the IGU. Finally, the first robot articulates as necessary to place the IGU on the IGU storage rack.

Alternative embodiments utilizing the second robot may operate in substantially the same way. In this example, the first robot can grip the front side of the first lite, and then align the first lite with the applicator track so the spacer applicator can apply the spacer to the back side of the first lite. Next, the first robot may align the first lite with the second lite to form the 5-sided enclosure, fill the 5-sided enclosure with gas, and seal the two lites together, as described above, forming a first IGU. Then, the first IGU may be conveyed into alignment with the second robot. The second robot may align the first IGU with the applicator track as the secondary sealant applicator applies the secondary sealant to the first IGU's peripheral edges. Finally, the second robot may articulate to place the first IGU on the IGU storage rack. In this embodiment, the first robot can assemble a second IGU while the secondary sealant is applied to the first IGU. Thus, the first robot and the second robot may operate concurrently to reduce the manufacturing time.

According to another example embodiment of the invention, an insulated glass unit assembly line can be arranged as a robotic work cell in a wrap-around, or “U”, pattern to further reduce the amount of space, time, and labor required to manufacture IGUs. Example embodiments arrange the assembly line around at least one robot supporting at least one robotic gripper which is adapted to grip and handle glass lights as well as completed insulated glass units. This embodiment of the invention is expected to reduce the physical space requirements of the manufacturing process and reduce necessary manual labor. An example embodiment of the robotic work cell assembly line can be fully operated by a single worker who can easily complete the tasks of loading lites to the assembly line and unloading completed IGUs due to the workstation's close proximity of each station. Furthermore, should the assembly line experience any issues during operation, a single worker can more easily diagnose and respond to the issue because the single worker can readily observe and monitor each stage of the assembly line when positioned proximate or in between the in-feed station for lites and outfeed station for completed IGUs.

According to example embodiments of the invention, an insulated glass unit assembly line arranged in a wrap-around pattern can make use of a single robot whereas some conventional automation approaches require multiple robots. In an example embodiment, the single robot can be a six-axis arm robot. An embodiment utilizing only one robot is expected to significantly reduce setup and maintenance costs of the assembly line.

In such an example embodiment, the robot can be positioned adjacent to and within reach of three workstations.

One workstation provides a first glass lite at a location at which the robot can grip and lift the first glass light. A workstation within reach of the robot includes a spacer applicator to apply a spacer material around the perimeter of the first glass lite while the first glass lite is supported by the robot, a first workstation then provides a second glass lite and a location to facilitate mating the first glass lite with the second glass lite after the spacer material has been applied thus creating an at least partially primary sealed IGU. A third workstation includes a secondary sealant applicator that applies edge sealant to the least partially primary sealed IGU around at least a part of the edge of the primary sealed IGU.

In an example embodiment, an assembly line arranged in a wrap-around pattern includes a loading station, a first conveyer, a washer station, a first workstation, a robot supporting and manipulating a robotic gripper, a second workstation, a spacer applicator, a third workstation, a second conveyer, an edge sealant applicator, a gas press station, a fourth workstation, and an IGU storage rack. In some example embodiments, an assembly line arranged in a wrap-around pattern can also include a standby rack.

In operation, according to an example embodiment, a worker loads a first lite onto a loading station. The first lite is then conveyed via a first conveyor to a washer station where the first lite is cleaned. Once the first lite is cleaned, the first conveyor moves the first lite out of the washer and onto a standby rack. The first lite is then further conveyed into a first workstation if no lite or IGU is present in the first workstation. A robot then uses a glass-gripper head to pick up and move the first lite to a second workstation where a spacer applicator is present. The robot supports the first lite as the spacer applicator applies a spacer sequentially along each edge of the back side of the first lite.

At any time shortly after the first lite has left the loading station, the worker loads a second lite onto the loading station. The second lite is conveyed through the washer and remains at the standby rack until the first lite has been lifted by the robot. The first lite may exit the washer simultaneously as the second lite enters the washer. While the first lite is having the spacer applied the second lite is conveyed to the first workstation. Once the spacer has been applied to the first lite, the robot returns the first lite to the first workstation and mates the first lite with the second lite, creating an at least partially primary sealed IGU.

The robot then moves the at least partially primary sealed IGU to a third workstation where the at least partially primary sealed IGU is released onto a second conveyor. The third workstation includes an edge sealant applicator which applies edge sealant to the primary sealed IGU, leaving a portion of the IGU unsealed and creating a partially secondary sealed IGU. The partially secondary sealed IGU is then conveyed by the second conveyor into a gas press station that fills the partially secondary sealed IGU with a non-air gas. Next, the partially secondary sealed IGU containing the non-air gas is conveyed to a fourth workstation. At the fourth workstation the unsealed portion of the IGU is sealed, thus creating a completed IGU. The completed IGU is conveyed to an IGU storage rack where it can be unloaded by the worker.

In an example embodiment, the glass lites and IGUs proceed from station to station without intervention by a worker. Therefore, in such an embodiment, a single worker is needed to load glass lites onto the loading station and to move completed IGUs from the IGU storage rack. This minimal interaction reduces the risk of human error and streamlines the IGU assembly process.

Additionally, a one man robotic cell optimizes the amount of units produced per worker on the assembly line. In an example embodiment, a one man robotic work cell can have a cycle time of 45 seconds without a grid and a roughly 1 minute cycle time with a grid. Further, the addition of a second application station can reduce cycle time to about 30 seconds without a grid.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a block diagram of an example insulated glass unit assembly sequence according to the prior art;

FIG. 2 is a perspective view of an insulated glass unit assembly line according to an example embodiment of the invention;

FIG. 3 is a perspective view of an insulated glass unit assembly line according to another example embodiment of the invention;

FIG. 4 is a perspective view of an insulated glass unit assembly line including a robotic glass picker and a first and second following robots according to an example embodiment of the invention;

FIG. 5 is a plan view comparing the floor plan and space requirements of a conventional insulated glass unit assembly line in comparison with an example embodiment of the invention

FIG. 6 is a perspective view of a robotic automated lite picker according to an example embodiment of the invention;

FIG. 7 is a perspective view of the robotic automated lite picker of FIG. 6 in a different orientation;

FIG. 8 is a perspective view of the robotic automated lite picker of FIG. 6 in an orientation in which a light is placed on a vertical conveyor

FIG. 9 is a perspective view of a glass gripper assembly with suction cups in an extended position;

FIG. 10 is a perspective view of the glass gripper assembly with the doctrine cups in a retracted position;

FIG. 11 is a perspective view of a gas filling and wetting station including a robot in a first orientation;

FIG. 12 is a perspective view of the gas filling and wetting station robot and a second orientation;

FIG. 13 is a perspective view of the gas filling and wetting station robot in a third orientation;

FIG. 14 is a perspective view of a gas filling enclosure;

FIG. 15 is a perspective view of a spacer applicator robot and a spacer applicator station according to an example embodiment of the invention;

FIG. 16 is another perspective view of the spacer applicator robot and the spacer applicator station according to an example embodiment of the invention;

FIG. 17 is another perspective view of the spacer applicator robot and spacer application station according to an example embodiment of the invention;

FIG. 18 is another perspective view of the spacer applicator robot and spacer application station;

FIG. 19 is a perspective view of a spacer applicator head according to an example embodiment of the invention;

FIG. 20 is a perspective view of a secondary sealant applicator head according to an example embodiment of the invention;

FIG. 21A is a perspective view of an insulated glass unit assembly line in a wrap-around arrangement according to an example embodiment of the invention; and

FIG. 21B is a perspective view of the insulated glass unit assembly line depicted in FIG. 21A.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

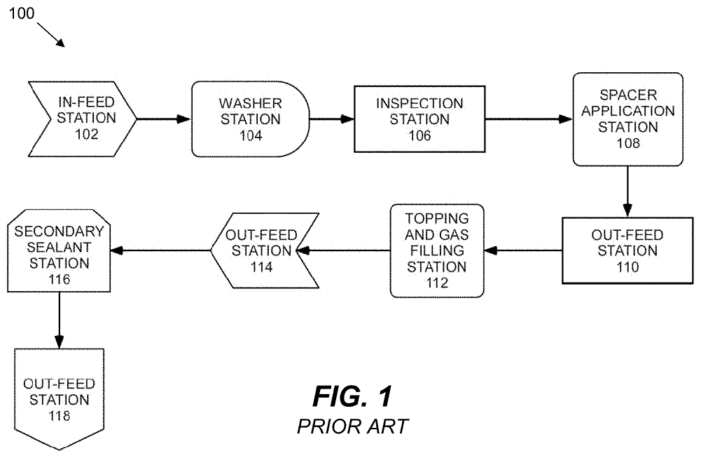

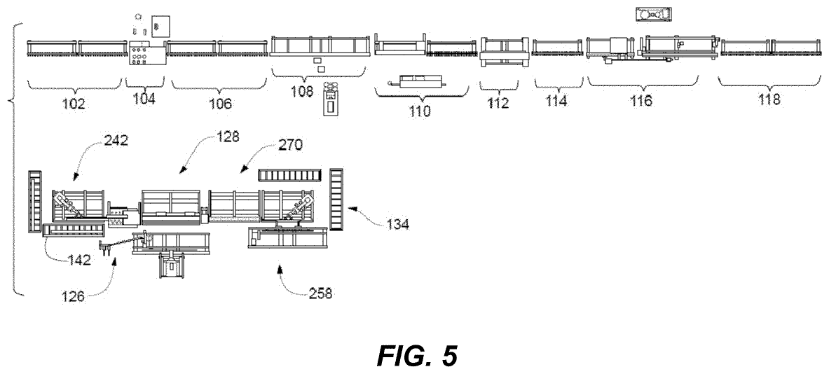

Referring to FIG. 1, an example prior art assembly line 100 and method is depicted in a block diagram. According to the example prior art, in-feed station 102 is followed by washer station 104. Washer station 104 is followed by inspection station 106. Inspection station 106 transfers insulated glass lites to the spacer application station 108 at which spacer material is applied to an insulated glass lite. The spacer applied light is then conveyed to outfeed station 110 and further conveyed to topping and gas filling station 112. At topping and gas filling station 112 a second light is applied on an opposing side of the spacer material from the first lite to create an insulated glass unit which is primary sealed. In addition, a non-air gas, such as argon, is optionally placed within the space between the lites formed by the spacer material to increase the energy efficiency of the insulated glass unit. The insulated glass unit is next conveyed to out-feed station 114 and then to secondary sealant station 116. At secondary sealant station 116, secondary sealant is applied around a periphery of the insulated glass unit. The completed insulated glass unit is then transferred to out-feed station 118, from which it is removed for storage and/or delivery. As can be seen, the prior art manufacturing approach includes many steps and results in an assembly line of considerable length, requiring a substantial amount of physical space in a manufacturing facility. In the conventional facility depicted in FIG. 5, the length is approximately 157′9″ with the capability of processing insulated glass units up to ten feet in length.

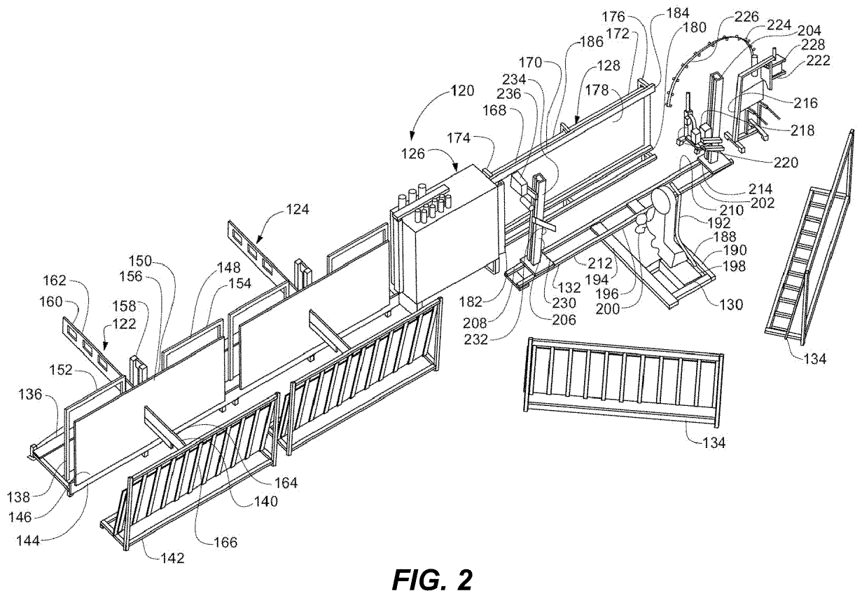

Referring now to FIG. 2, an example insulated glass assembly line 120 according to an example embodiment of the invention is depicted. Insulated glass assembly line 120 generally includes first automated lite picker 122, second automated lite picker 124, lite washer 126, vertical gas filling and wetting station 128, robot 130, applicator station 132 and IGU storage racks 134.

First, automated lite picker 122 generally includes ground engaging support 136, vertical conveyor 138, picker arm 140 and lite storage rack 142.

Ground engaging support 136 supports vertical conveyor 138. Vertical conveyor 138 generally includes support platform 144, conveyor 146 and support frames 148. Support platform 144 and conveyor 146 present a horizontal surface upon which lites 150 rest as lites 150 are conveyed along IGU assembly line 120 by movement of conveyor 146.

Conveyor 146 may conveniently be made as a belt conveyor or a roller conveyor. Other conveyors known to those skilled in the art may be utilized as well.

Support frames 148 generally include pre-picker arm support frame 152 and post picker arm support frame 154. Each of support frames 148 present roller beams 156. Roller beams 156 may include roller wheels, roller bearings or other roller structures.

Picker arm 140 is supported by picker arm vertical support column 158 and extension arm assembly 160. Extension arm assembly 160 generally includes extension arm track 162 coupled to and supported by picker arm vertical support column 158 and extension arm slide 164 which is slidably supported within extension arm track 162. Extension arm slide 164 and extension arm track 162 cooperate in much the same fashion as a drawer slide and track. Extension arm slide is coupled to and supports glass gripper 166, which is configured to grip and support lites 150 typically by the application of vacuum or suction. Substantially vertical, in this context, means that the lites are held at an orientation that is less than about 25 degrees of true vertical. More typically, the lites are held within 6 to 10 degrees of true vertical, for example, at 6 degrees of true vertical.

First lite storage rack 142 is located substantially opposite from first automated lite picker and is structured to support lites 150 and is tilted slightly backwards from vertical so that lites 150 are held in place by gravity.

Second automated lite picker 124 is substantially similar to first automated lite picker 122 and includes similar structures to first automated lite picker 122. Therefore, second automated lite picker 124 will not be further described here.

Lite washer 126 is generally conventional in design and known to those of skill in the art. Lite washer 126 is structured to wash lites 150 and need not further be described here.

Vertical gas filling and wetting station 128 generally includes vertical conveyor 168 and gas fill enclosure 170.

Vertical conveyor 168 generally includes vertical support 172. Vertical support 172 includes in feed 174, outfeed 176, rear wall 178 and conveyor 180. In feed 174 is located proximate lite washer 126.

Gas fill enclosure 170 includes in feed side movable door 182 and terminal door 184. Movable door 182 may be located at an in-feed side of gas fill enclosure 170, for example proximate to in-feed side 174, and is shiftable between a gas filling position and a resting position. Terminal side door 184 may be located at a terminal side of gas fill enclosure 170, for example proximate to out-feed side 176, and is optionally shiftable between a gas filling position and a resting position. Gas fill enclosure 170 also includes gas source 186. At least one of movable door 182 and terminal door 184 may include nozzles or ports (not shown) in fluid communication with gas source 186. Alternatively, gas source 186 may be in fluid communication with conveyor 180 so that the gas is injected from the bottom of gas fill enclosure 170. Additional embodiments may include other structures or positions for gas source 186. Robot 130 generally includes robot support track 188, robot base support platform 190 and articulated robot arm assembly 192. Robot base support platform 190 is supported by robot support track 188. Robot base support platform 190 in turn, supports articulated robot arm assembly 192.

Robot support track 188 generally includes support rails 194 and perpendicular applicator track coupling 196. Support rails 194 stabilize robot support track 188.

Robot base support platform 190 includes movable robot dolly 198. Movable robot dolly 198 is movably supported on robot support track 188 to facilitate travel of robot 130 along robot support track 188.

Articulated robot arm assembly 192 generally includes movable robot arm 198 and glass gripper head 200. Articulated robot arm assembly 192 and glass gripper head 200 are of sufficient strength and mobility to support the largest size of insulated glass units expected to be processed.

Spacer application station 108 generally includes applicator track 202, spacer applicator 204 and secondary sealant applicator 206. In the depicted example embodiment, applicator track 202 is coupled to robot support track 188 at perpendicular applicator track coupling 196. Spacer applicator 204 and secondary sealant applicator 206 are movable along applicator track 202. Applicator track 202 is oriented generally parallel to insulated glass assembly line 120. Applicator track has first end 208 and second end 210. In the depicted embodiment, spacer applicator 204 has a resting position proximate first end 208 and secondary sealant applicator 206 has a resting position proximate second end 210. In the depicted embodiment, applicator track 202 includes parallel horizontal rails 212, but other configurations are also possible.

Spacer applicator 204 generally includes spacer applicator base 214, spacer applicator support column 216, spacer applicator vertical traveler support 218, spacer applicator head 220, and spacer storage unit 222. Spacer applicator base 214 rests movably on horizontal rails 212 of applicator track 202 and supports spacer applicator support column 216. Spacer applicator vertical traveler support 218 is coupled to spacer applicator support column 216, along which spacer applicator vertical traveler 218 can move vertically. Spacer applicator head 220 is movably coupled to spacer applicator vertical traveler support 218 on which spacer applicator head 220 can move rotationally and vertically. Spacer applicator head 220 is operably coupled to spacer storage unit 222 to receive a supply of spacer material.

Spacer storage unit 222 in the depicted embodiment generally includes flexible spacer applicator head coupling 224, spacer supply conduit 226 and stored spacer material 228.

Secondary sealant applicator 206 generally includes secondary sealant applicator base 230, secondary sealant support column 232, secondary sealant vertical traveler support 234 and secondary sealant applicator head 236. Secondary sealant applicator base 230 is movably supported by applicator track 202. Secondary sealant applicator base 230 supports secondary sealant support column 232, which in turn supports secondary sealant vertical traveler support 234. Secondary sealant vertical traveler 234 can move vertically along secondary sealant support column 232. Secondary sealant applicator head 236 is movably coupled to secondary sealant vertical traveler support 234, on which secondary sealant applicator head 236 can move rotationally and vertically. Secondary sealant applicator head 236 is coupled in fluid communication with a supply of secondary sealant (not shown).

IGU storage racks 134 are adapted to receive and store completed insulated glass units. IGU storage racks 134 are conventional in design and need not be further described here. They are, however, very similar in structure to the lite storage racks 142.

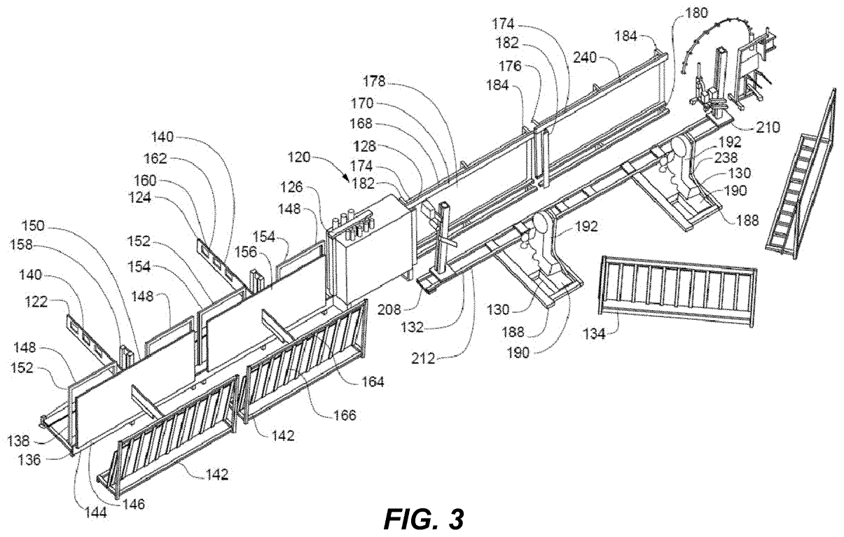

Referring to FIG. 3, an alternate embodiment of the invention is depicted. According to the embodiment depicted in FIG. 3 first robot 130 and second robot 238 are utilized. First robot 130 and second robot 238 are similar or identical in structure and need not be further described here. The depicted embodiment also includes topping and gas filling station 112 as well as a following station 240. Following station 240 is similar to topping and gas filling station 112 but need not include any gas filling structures.

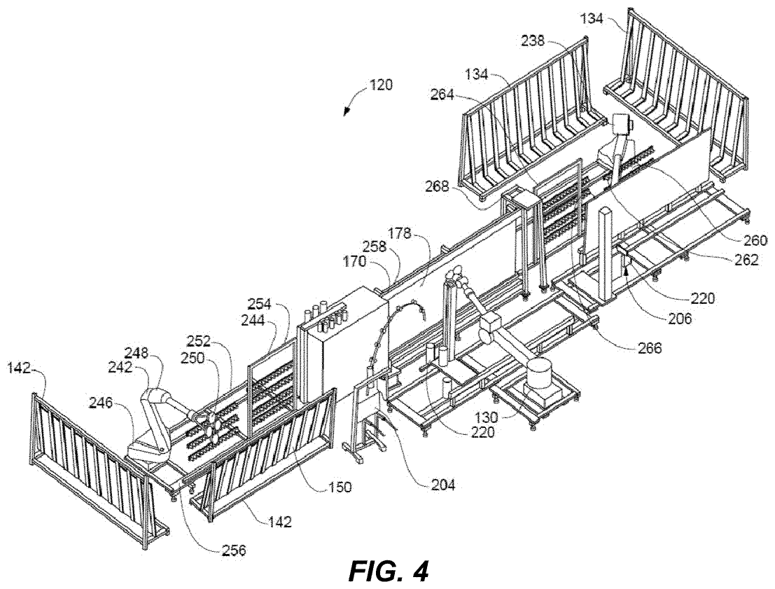

Referring to FIG. 4, another alternative embodiment of the invention is depicted. This embodiment includes robotic lite picker 242, robotic vertical conveyor 244, and corking station 270. It is notable that this embodiment, like the other embodiments the invention disclosed by this specification, is substantially shorter in length than a conventional insulated glass processing facility. As can be seen by reference to FIG. 5, the depicted embodiment has an approximate length of 62′6″ for a facility that is adapted to process insulated glass units up to ten feet in length. This example represents a space savings of approximately 60% over the example conventional insulated glass processing facility.

Robotic glass lite picker 242 generally includes robot base support platform 246, articulated robot arm assembly 248, glass gripper head 250 and roller beams 252. Robot base support platform 246 supports articulated robot arm assembly 248 which in turn supports glass gripper head 250 and roller beams 252. Glass gripper head 250 is arranged relative to roller beams 252 to grip glass lites 150 while glass lights 150 are in contact with or proximate to roller beams 252.

Robotic vertical conveyor 244 generally includes roller beams portion 254 and robot pass-through portion 256. The roller beams portion 254 is generally similar to roller beams 156. However, robot pass-through portion 256 is sized and shaped to accommodate roller beams 252 when articulated robot arm assembly 248 is aligned in generally coplanar alignment with roller beams portion 254.

Robotic glass lite picker 242 may be located in front of robotic vertical conveyor 244 or, as depicted in FIG. 4, behind robotic vertical conveyor 244. The embodiment of the invention depicted in FIG. 4 has an even smaller footprint and shorter length than the embodiments depicted in FIG. 2 and FIG. 3.

In contrast to the embodiment depicted in FIG. 3, in the embodiment of FIG. 4, second robot 238 is located behind secondary sealing station 258. In the depicted embodiment, the second robot 238 includes glass gripper head 260 coupled to roller beams 262. Secondary sealant conveyor 264 located at secondary sealing station 258 and adjacent to roll press 268 is similar to robotic vertical conveyor 244 in that it includes roller beams portion 254 and robot pass-through portion 266. This structure enables glass gripper head 260 with roller beams 262 to receive a primary sealed IGU, and to support and present the primary sealed IGU for secondary sealant application.

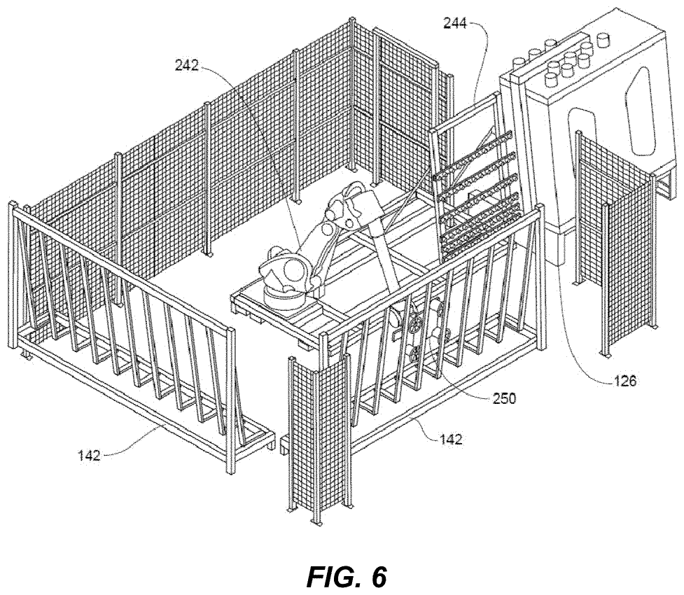

FIGS. 6, 7 and 8 to depict various positions of robot lite picker 242 as articulated during a manufacturing process.

Referring to FIG. 6, robotic lite picker 242 is depicted along with robotic vertical conveyor 244 and lite washer 126. Lite storage racks 142 are depicted as well. Glass gripper head 250 in this depiction is located proximate to first lite storage rack 142.

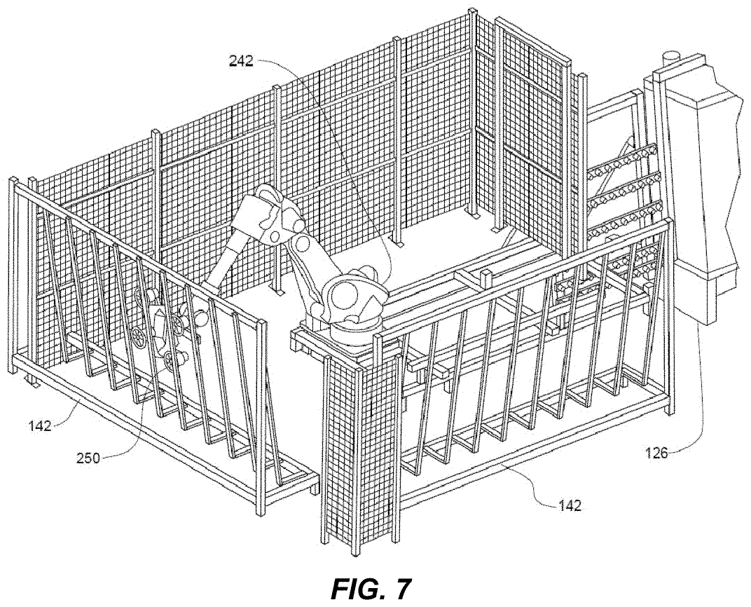

Referring to FIG. 7, robotic lite picker 242 is depicted with glass gripper head 250 located proximate to second lite storage rack 142.

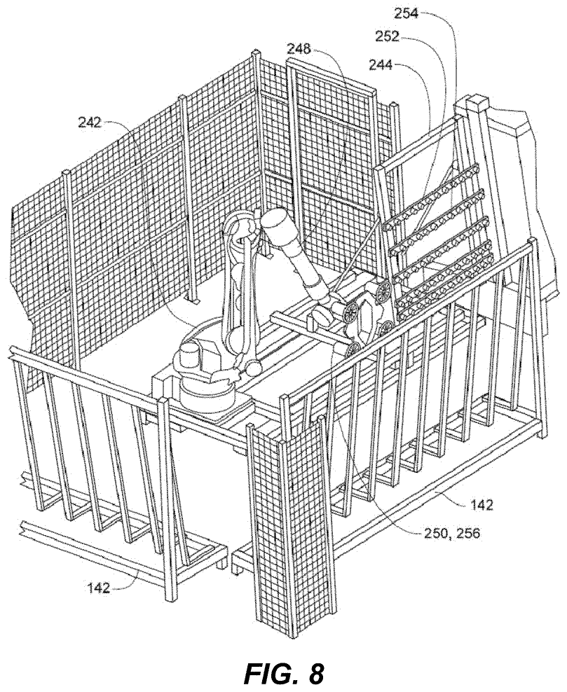

Referring to FIG. 8 robotic lite picker 242 is depicted with glass gripper head 250 located proximate robotic vertical conveyor 244. Here glass gripper head 250 is generally aligned with roller beams 252 by motion of articulated robot arm assembly 248 so that the glass lite can be transferred to robotic vertical conveyor 244. Glass gripper head 250 can pass through robot pass-through portion 256 and align a glass lite with roller beams portion 254 so that the glass lite can be conveyed by robotic vertical conveyor 244. Two lite storage racks 142 are present to accommodate the use of two different types of glass lites in the manufacturing process. As discussed elsewhere in this application, one glass lite may have a low E coating that facilitates improved energy efficiency. Another, glass lite may lack such a coating. The 2 lite storage racks 142 each accommodate one of the types of glass lites.

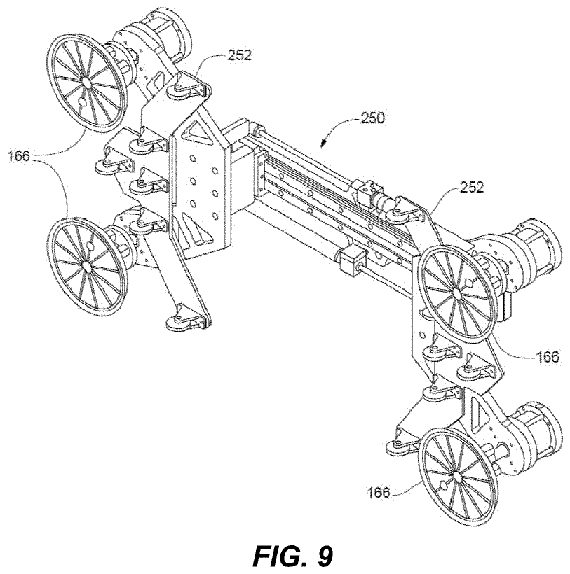

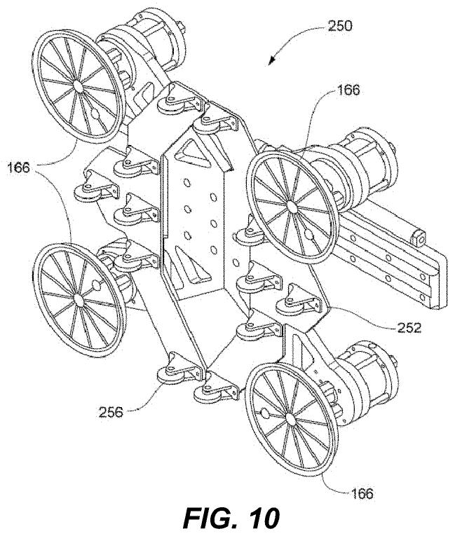

Referring to FIGS. 9 and 10 in an example embodiment of glass gripper head 250 is depicted. In FIG. 9, glass gripper head 250 is depicted with glass grippers 166 spread apart which is useful when gripping and supporting larger glass lites. In FIG. 10, glass gripper head 250 is depicted with glass grippers 166 moved closer together which is useful when gripping and supporting smaller glass lites. FIGS. 9 and 10 also depict an alternative embodiment of roller beams 252.

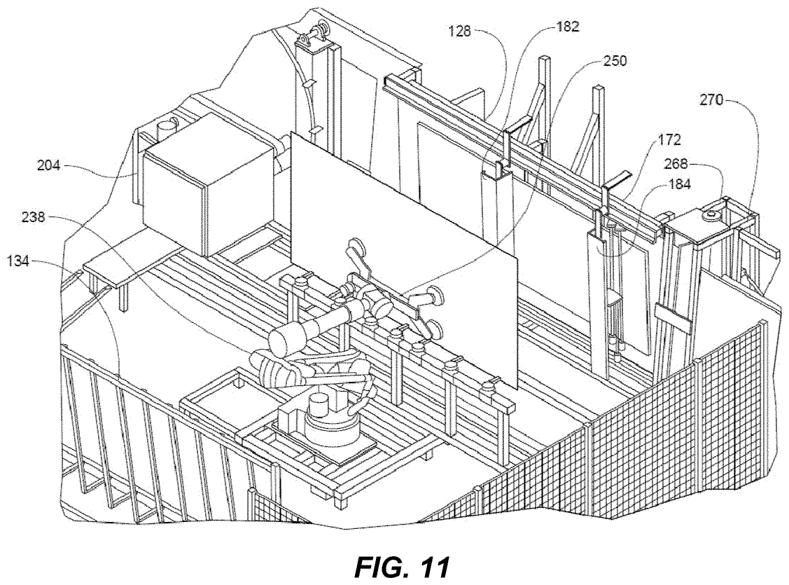

Referring now to FIGS. 11, 12 and 13, robotic glass filling and wetting station 128 is depicted.

In FIG. 11, third robot 238 is depicted supporting a glass lite proximate glass filling and wetting station 128 such that the glass lite with spacer material applied can be mated with a further glass lite for gas filling and to create an insulated glass unit.

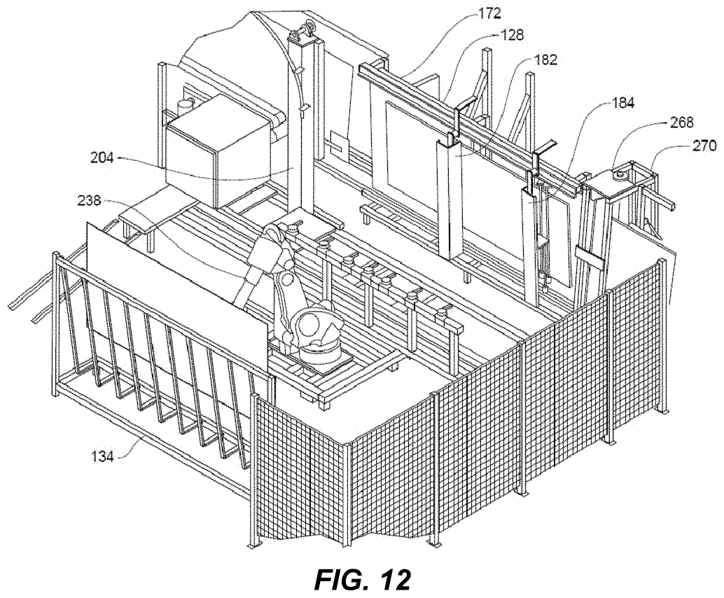

Referring to FIG. 12 a completed insulated glass unit is supported by third robot 238 proximate lite storage rack 142 in which completed insulated glass units may be stored.

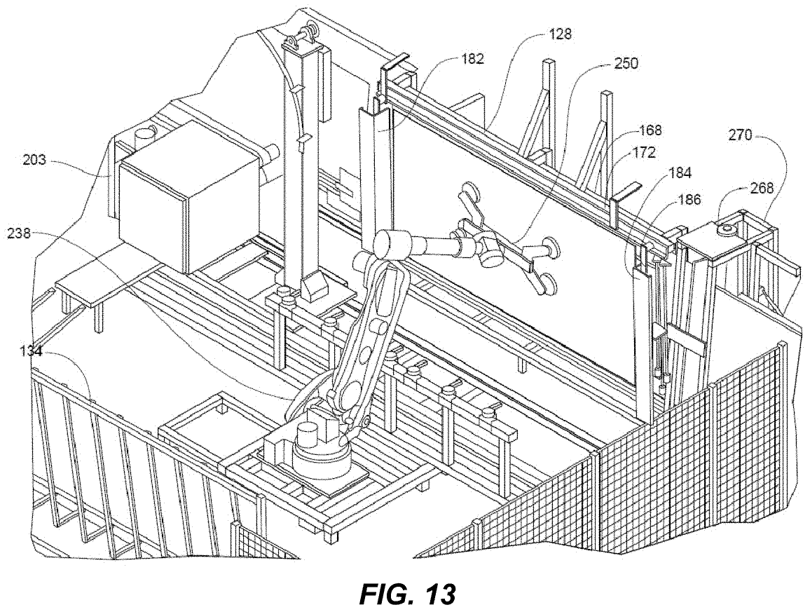

Referring to FIG. 13, second robot 238 is depicted mating a spacer applied lite to a further glass lite during the gas filling and wetting process.

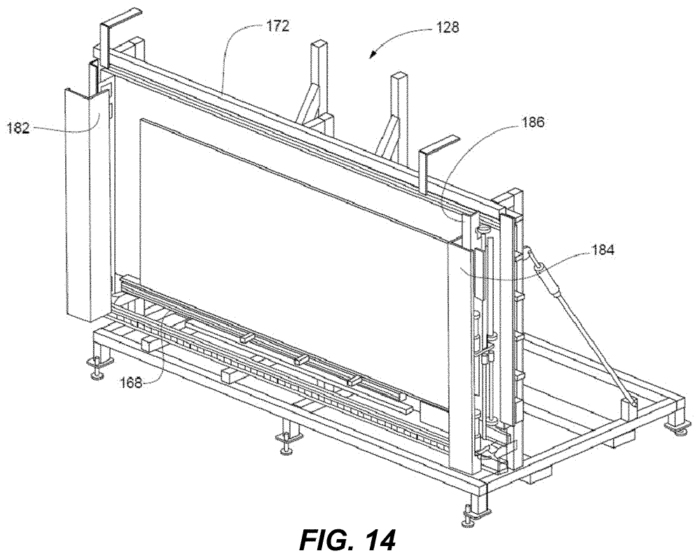

Referring now to FIG. 14, vertical gas filling and wetting station 128 is depicted including vertical conveyor 168. Vertical conveyor 168 includes vertical support 172 and in feed side movable door 182, terminal side door 184 and gas source 186. In the depicted embodiment both in feed side movable door 182 terminal side door 184 are movable to accommodate various sized insulated glass units.

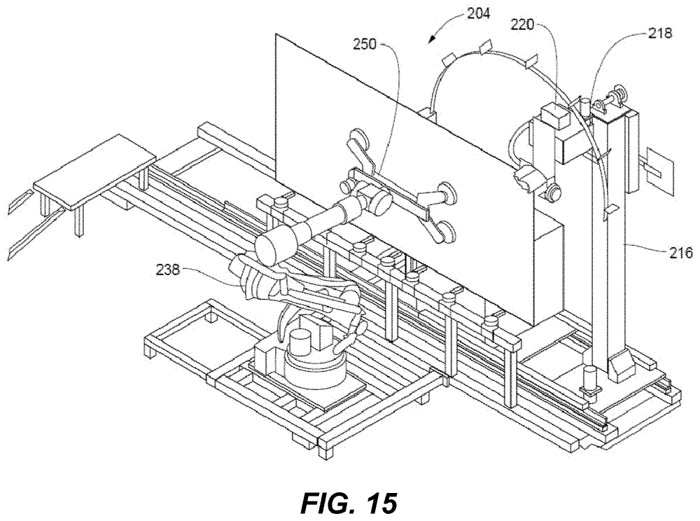

Referring now to FIGS. 15, 16, 17, and 18, applicator station 132 is depicted along with third robot 130. In each of these FIGS., third robot 130 is depicted supporting a glass lite proximate spacer applicator 204 at which spacer material is applied to a back side of the glass lite.

In FIG. 15, spacer applicator head 220 is depicted at the beginning of spacer application proximate an upper right corner of the glass lite.

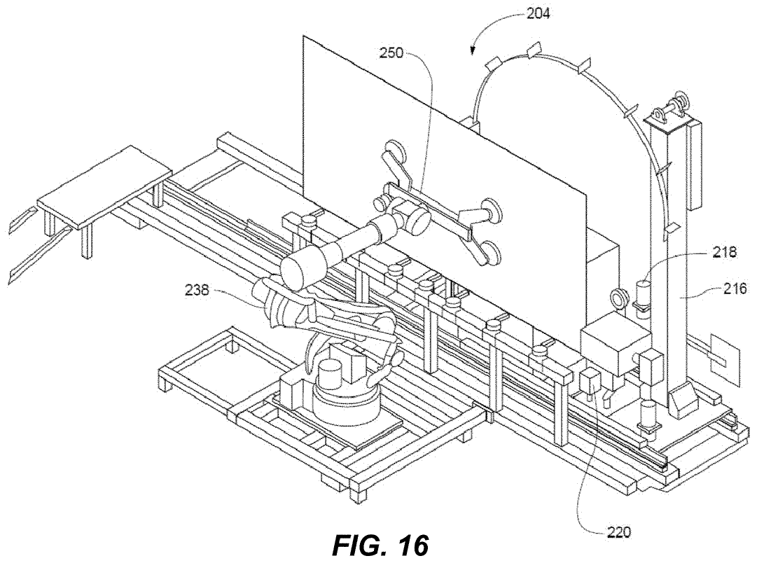

In FIG. 16, spacer applicator head 220 i will s depicted at a lower right corner of the glass lite having applied spacer material to the right edge glass lite.

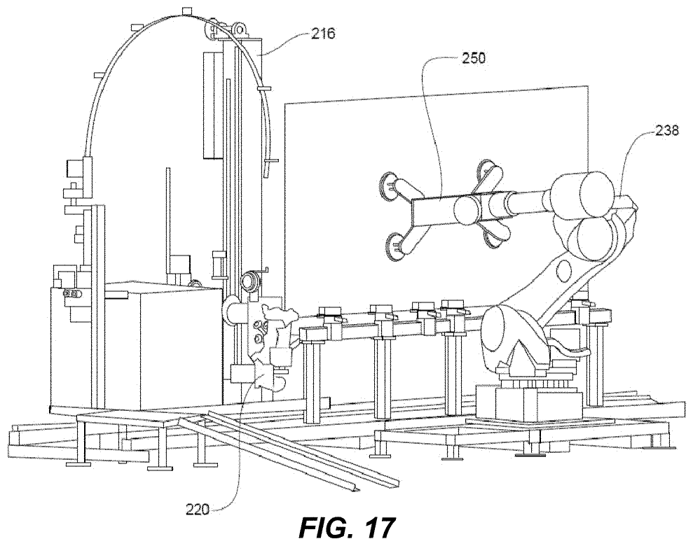

In FIG. 17, spacer applicator head 220 is depicted at a lower left corner of the glass lite having applied spacer material to the right edge of the glass lite and the bottom edge of the glass lite.

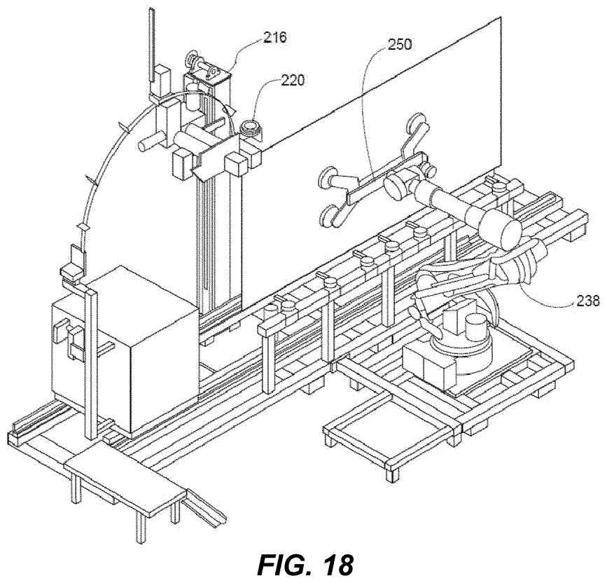

In FIG. 18, spacer applicator head 220 is depicted at an upper left corner of the glass lite having applied spacer material to the right edge of the glass lite, the bottom edge of the glass lite and the left edge of the glass lite. Spacer applicator head 220 that applies spacer to a top edge of the glass lite returning to the position depicted in FIG. 15.

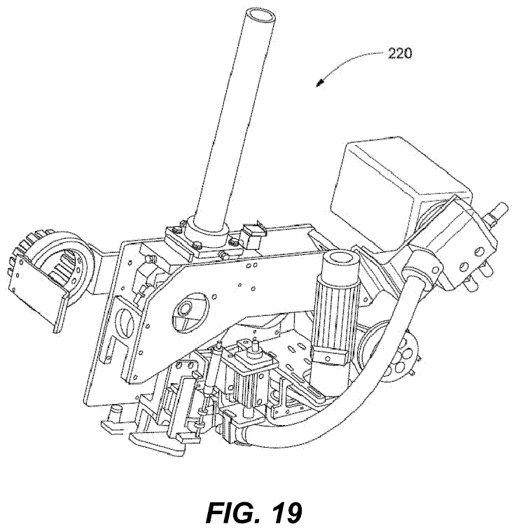

Referring now to FIG. 19, spacer applicator head 220 is depicted in isolation. Features of spacer applicator head 220 are known to those skilled in the art and need not be further described here.

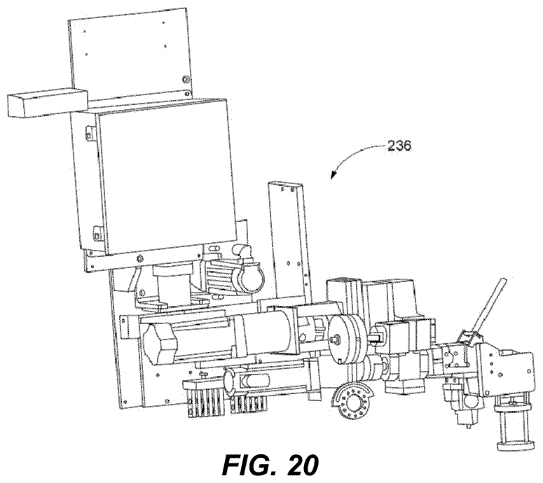

Referring now to FIG. 20, secondary sealant applicator head 236 is depicted in isolation. Features of secondary sealant applicator head 236 are known to those skilled in the art need not be further described here.

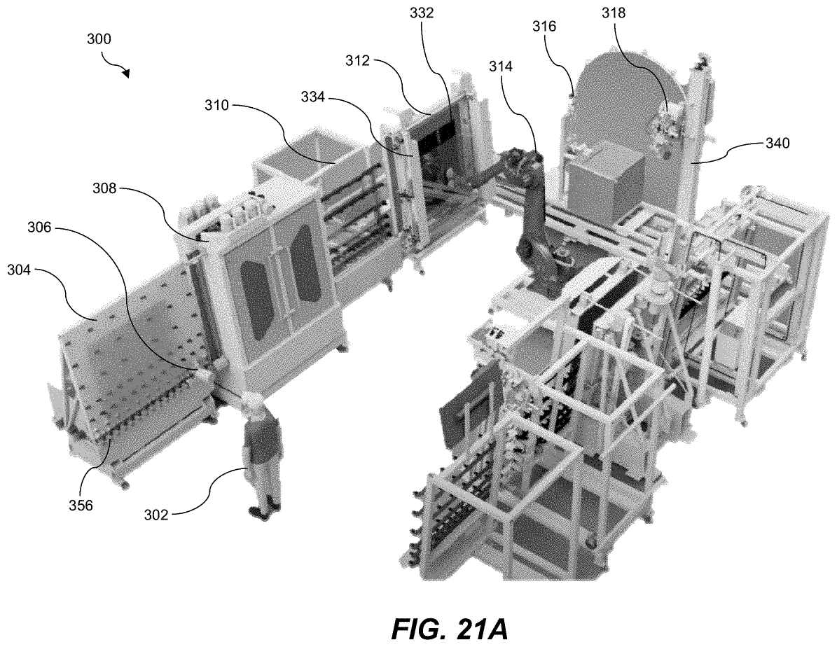

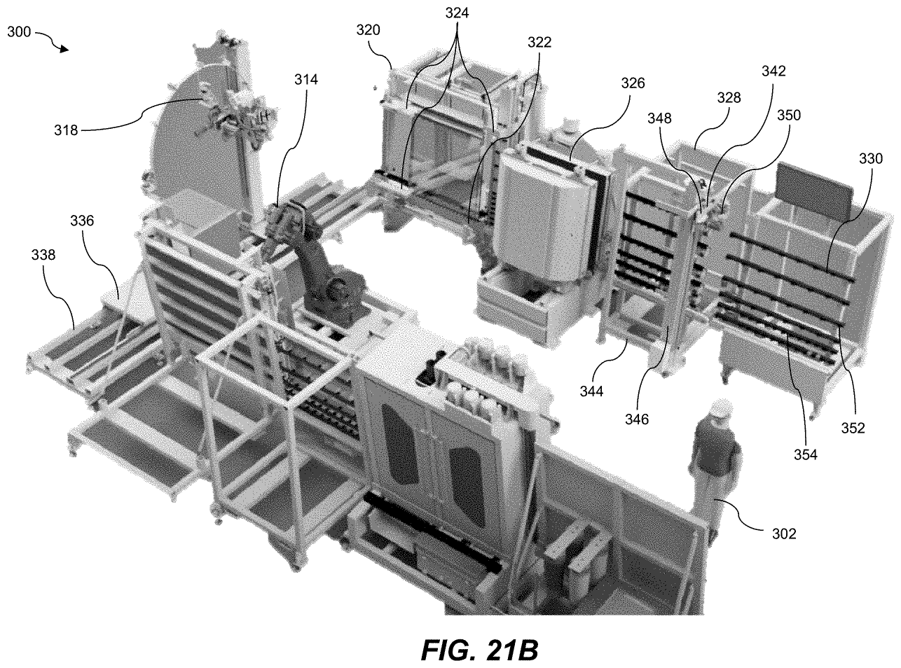

Referring now to FIGS. 21A-B, insulated glass unit assembly line 300 arranged in a wrap-around, or “U”, pattern is depicted. A wrap-around insulated glass unit assembly line 300 can reduce the amount of space, time, and manual labor required to manufacture IGUs. Wrap-around insulated glass assembly line 300 designed for a single worker 302 generally includes loading station 304, first conveyer 306, washer station 308, standby rack 310, first workstation 312, robot 314, second workstation 316, spacer applicator 318, third workstation 320, second conveyer 322, edge sealant applicator 324, gas press station 326, fourth workstation 328, and IGU storage rack 330.

Continuing to refer to FIG. 21A-B, loading station 304 includes a support platform, stabilization structures, and conveying means. Loading station 304 stores lite 150 in a substantially vertical orientation until washer station 308 is ready to intake another lite 150.

First conveyor 306 and second conveyor 322 move lites 150, in tandem fashion, along the travel axis of the assembly line. First conveyor 306 and second conveyor 322 can include supports, generally including parallel beams 352, rails 354, or other stabilization structures that stabilize lites 150 as they travel. In embodiments, first conveyor 306 and second conveyor 322 include multiple parallel rows of passive wheels or rollers 356 over which lite 150 safely travels under the impetus of the conveyor. For example, the rollers may take the form of caster wheels or ball bearings.

According to an example embodiment, first conveyor 306 extends along the bottom edge of loading station 304, washer station 308, standby rack 310, and first workstation 312. In example embodiments, first conveyor 306 can be formed as separate conveying structures within each station that are aligned to transfer lites 150 to the next station. In such an embodiment loading station 304, washer station 308, standby rack 310, and first workstation 312 each include separate rollers and stabilization structures.

According to an example embodiment, second conveyor 322 extends along the bottom edge of third workstation 320, gas press station 326, fourth workstation 328, and IGU storage rack 330. In example embodiments, second conveyor 322 can be assembled as separate conveying structures within each station that are aligned to transfer lites 150 an adjacent station. In such an embodiment third workstation 320, gas press station 326, fourth workstation 328, and IGU storage rack 330 each include separate rollers and stabilization structures.

Washer station 308 is generally conventional and will not be further described here. Washer station 308 cleans lites 150. Washer station 308 can clean lites one at a time as they are conveyed in tandem fashion along the assembly line. Lites 150 are conveyed from loading station 304 into washer 308 and, once washed, further conveyed to standby rack 310.

Standby rack 310 is a lite storage rack that can hold lites 150 until first workstation 312 is empty. In example embodiments, standby rack 310 permits the glass lites 150 to be stored in a substantially vertical orientation. Substantially vertical, in the context of this application means within 15° of vertical. According to one example embodiment of the invention, insulated glass unit assembly line 300 may include a series of standby racks between washer station 308 and first workstation 312.

First workstation 312 includes support base, support panel 332 and compression arms 334. The support base keeps first workstation 312 still during operation and is coupled to support panel 332 and compression arms 334. Compression arms 334 our movable between a first position in which compression arms 334 our retracted to allow placement and removable of a lite 150 or an IGU and a second position in which compression arms 334 apply force to an at least partially primary sealed IGU to facilitate the primary seal. Support panel 332 permits the glass lites 150 to be precisely positioned in a substantially vertical orientation.

Robot 314 includes a robot base support platform 358 and an articulated robot arm assembly 360. The robot base support platform 358 supports the articulated robot arm assembly 360. Articulated robot arm assembly 360 generally includes movable robot arm 362 and glass gripper head 364. The articulated robot arm assembly 360 and the glass gripper head 364 are of sufficient strength and mobility to support the largest size of insulated glass units expected to be processed. Robot 314 is positioned so that the articulated robot arm assembly 360 can reach first workstation 312, second workstation 316, and third workstation 320.

Second workstation 316 includes spacer applicator 318, spacer applicator base 336, spacer applicator support track 338, and spacer applicator support column 340. Spacer applicator 318 includes spacer applicator vertical traveler, spacer applicator head, and spacer storage unit. Spacer applicator base 336 rests movably on applicator track 338 and supports spacer applicator support column 340. The spacer applicator vertical traveler is moveable vertically along spacer applicator support column 340. The spacer applicator head is movably coupled to the spacer applicator vertical traveler on which the spacer applicator head can move rotationally and vertically. The spacer applicator head is operably coupled to the spacer storage structure to receive a supply of spacer material. The spacer storage unit generally includes a flexible spacer applicator head coupling, a spacer supply conduit, and a stored spacer material.

In operation, according to an example embodiment, worker 302 loads a first lite 150 onto loading station 304. The first lite 150 is then conveyed via first conveyor 306 to washer station 308 where the first lite 150 is cleaned. Once the first lite 150 is cleaned, first conveyor 306 transfers the first lite 150 out of washing station 308 and onto standby rack 310. The first lite 150 is then further conveyed to first workstation 312 if no lite 150 or partially completed IGU is present in first workstation 312. Once the first lite 150 is present in first workstation 312, robot 314 uses a glass-gripper head 364 to pick up and move the first lite 150 to second workstation 316 where spacer applicator 318 is present. Robot 314 supports the first lite 150 as spacer applicator 318 applies a spacer sequentially along each edge of the back side of the first lite 150.

At any point after the first lite 150 has left loading station 304, worker 302 loads a second lite 150 onto loading station 304. The second lite 150 is conveyed through washer 308 and remains at standby rack 310 until first lite 150 has been lifted by robot 314. First lite 150 may exit washer 308 simultaneously as the second lite 150 enters washer 308. While the first lite 150 is having the spacer applied the second lite 150 is conveyed into first workstation 312. Once the spacer has been applied to the first lite 150, robot 314 returns the first lite 150 to first workstation 312 and mates the first lite 150 with the second lite 150, creating an at least partially primary sealed IGU.

Robot 314 then moves the primary sealed IGU to third workstation 320 where the primary sealed IGU is released onto second conveyor 322. Third workstation 320 includes edge sealant applicator 324 which applies edge sealant to the primary sealed IGU, leaving a portion of the IGU unsealed and creating a partially secondary sealed IGU. The partially secondary sealed IGU is then conveyed by second conveyor 322 into gas press station 326 that fills the partially secondary sealed IGU with a non-air gas. Next, the partially secondary sealed IGU and non-air gas is conveyed to fourth workstation 328. At fourth workstation 328 the unsealed portion of the IGU is sealed, thus creating a completed IGU. The completed IGU is conveyed to IGU storage rack 330 where it can be unloaded by worker 302.

Structuring insulated glass unit assembly line 300 around robot 314 reduces the physical space requirements of the manufacturing process. Additionally, the close proximity of loading station 304 and IGU storage rack 330 reduce manual labor required by worker 302 and allow worker 302 to quickly address any issues during operation of insulated glass unit assembly line 300.

In an example embodiment, glass lites 150 and IGUs proceed from station to station without intervention by worker 302. Therefore, in such an embodiment, a single worker is needed to load glass lites 150 onto the loading station and to move completed IGUs from the IGU storage rack. This minimal interaction reduces the risk of human error and streamlines the IGU assembly process.

Further in operation, first workstation securely positions a first lite 150 against support panel 332 until robot 314 is ready to lift the first lite 150 to second workstation 316. Once the first lite 150 has been lifted away by robot 314, a second lite 150 is conveyed, via first conveyor 306, into first workstation 312. Meanwhile, robot 314 holds the first lite 150 at second workstation 316 while spacer applicator 318 applies spacer to the perimeter of the first lite 150. Robot 314 then proceeds to align and mate the first lite 150, now with spacer applied, to the second lite 150 that is securely positioned against support panel 332. During mating, compression arms 334 move to partially overly the first lite 150 and compress the first lite 150 and second lite 150 together, forming a primary sealed IGU. Robot 314 then lifts the primary sealed IGU to third workstation 320.

Third workstation 320 includes edge sealant applicator 324. Each edge sealant applicator 324 generally includes an edge sealant base, three edge sealant applicator tracks, and three edge sealant applicator heads. The support base keeps third workstation 320 still during operation and is coupled to the three edge sealant applicator tracks and three edge sealant applicator heads. Each edge sealant applicator head is moveable along a corresponding edge sealant applicator track to apply edge sealant around the perimeter of the primary sealed IGU. The positions of the three edge sealant applicator tracks can be automatically adjusted based on the dimensions of the primary sealed IGU.

In operation, the three edge sealant applicator heads apply edge sealant simultaneously to save time before the partially secondary sealed IGU is conveyed by second conveyer 322 to gas press station 326. Additionally, a single vertically aligned edge sealant applicator track and corresponding edge sealant applicator head can, for example, be used to apply edge sealant to both vertically aligned edges of the primary sealed IGU as the primary sealed IGU is conveyed.

Gas press station 326 includes a gas fill enclosure and a gas source. The gas fill enclosure generally includes nozzles or ports in fluid communication with the gas source. Alternatively, the gas source may be in fluid communication with second conveyor 322 so that the gas is injected from the bottom of the gas fill enclosure. Additional embodiments may include other structures or positions for gas source.

In operation, the gas fill enclosure is shiftable between a gas filling position and a resting position. While in a resting position, the gas fill enclosure permits partially secondary sealed IGU's to be conveyed into and out of the gas fill enclosure through a gap between a front wall and a support wall. While in the gas filling position, the front wall moves toward the support wall, encapsulating any partially secondary sealed IGU positioned inside the gas fill enclosure and enabling non-air gas to fill the interior space of the partially secondary sealed IGU.

Fourth workstation 328 includes secondary edge sealant applicator 342. Secondary edge sealant applicator 342 generally includes secondary edge sealant applicator base 344, secondary edge sealant support column 346, secondary edge sealant vertical traveler 348, and secondary edge sealant applicator head 350. Secondary edge sealant applicator base 344 supports secondary edge sealant support column 346, which in turn supports secondary edge sealant vertical traveler support 348. Secondary edge sealant vertical traveler 348 is movable vertically along secondary edge sealant support column 346. Secondary edge sealant applicator head 350 is movably coupled to secondary edge sealant vertical traveler 348, on which secondary edge sealant applicator head 350 can move rotationally and vertically. Secondary edge sealant applicator head 350 is coupled in fluid communication with a supply of edge sealant (not shown).

In operation, secondary edge sealant applicator 342 finishes the partial secondary seal, resulting in a complete IGU. The complete IGU is then conveyed to IGU storage rack 330.

IGU storage rack 330 is adapted to receive and store completed insulated glass units. IGU storage rack 330 is conventional in design and need not be further described here. Storage racks 330 are, however, similar in structure to standby rack 310 and other lite storage racks. In example embodiments, multiple IGU storage racks 330 can be used. The use of two IGU storage racks 330, for example, increases the number of IGUs that can be manufactured in each production run because the robot can begin placing IGUs on the second IGU storage rack 330 once the first IGU storage rack 330 is full, without waiting for the first IGU storage rack 330 to be replaced or emptied by worker 302.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A method of manufacturing insulated glass units comprising:
lifting a first glass lite from a first workstation by applying a robotic gripper to a first surface of the first glass lite;
presenting the first glass lite to a second workstation supported by the robotic gripper;
mechanically applying spacer material proximate a perimeter of a second surface of the first glass lite at the second workstation while the first glass lite is supported by the robotic gripper;
robotically returning the first glass lite and applied spacer material to the first workstation and mating the first glass lite and applied spacer material to a second glass lite at the first workstation thus creating an at least partially primary sealed insulated glass unit;
robotically lifting the at least partially primary sealed insulated glass unit and moving the at least partially primary sealed insulated glass unit to a third workstation;
filling the at least partially primary sealed insulated glass unit with a non-air gas at the third workstation; and
edge sealing at least a portion of the at least partially primary sealed insulated glass unit to make an at least partially secondary sealed insulated glass unit.

2. The method of manufacturing insulated glass units as claimed in claim 1, further comprising:
manually introducing the first glass lite to a first conveyor; and
conveying the first glass lite to the first workstation.

3. The method of manufacturing insulated glass units as claimed in claim 1, further comprising:
manually introducing the second glass lite to the first conveyor; and
conveying the second glass lite to the first workstation.

4. The method of manufacturing insulated glass units as claimed in claim 1, further comprising:
releasing the at least partially primary sealed insulated glass unit at the third workstation onto a second conveyor; and
applying edge sealant to the at least partially primary sealed insulated glass unit while leaving an unsealed portion of the insulated glass unit unsealed thus creating a partially secondary sealed insulated glass unit.

5. The method of manufacturing insulated glass units as claimed in claim 1, further comprising:
conveying the at least partially primary sealed insulated glass unit into a gas press; and
filling the at least partially primary sealed insulated glass unit with a non-air gas.

6. The method of manufacturing insulated glass units as claimed in claim 1, further comprising:
conveying the at least partially primary sealed insulated glass unit filled with the non-air gas to a fourth workstation to be at least partially secondary sealed.

7. The method of manufacturing insulated glass units as claimed in claim 1, further comprising:
completing secondary sealing of the at least partially secondary sealed insulated glass unit thereby creating a completed insulated glass unit;
conveying the completed insulated glass unit to a fifth workstation; and
manually removing the completed insulated glass unit from the fifth workstation.

8. A robotic work cell to manufacture insulated glass units comprising:
a robotic gripper supported by a robot positioned and structured to lift a first glass lite from a first workstation by applying a robotic gripper to a first surface of the first glass lite;
a second workstation including a spacer material applicator structured to apply spacer material to a perimeter of the supported first glass lite presented to the second workstation while supported by the robotic gripper;
a third workstation reachable by the robot including a second conveyor; and
the third workstation comprising an edge sealant applicator;
wherein the first workstation, the second workstation and the third workstation are within reach of the robotic gripper as manipulated by the robot.

9. The robotic work cell to manufacture insulated glass units as claimed in claim 8, further comprising:
a first conveyor structured to receive and convey the first glass lite; and
the first workstation being downstream of the first conveyor and structured to receive the first glass lite conveyed and a second glass lite from the first conveyor.

10. The robotic work cell to manufacture insulated glass units as claimed in claim 8, further comprising:
wherein the third workstation is reachable by the robot and includes a second conveyor; and further comprising:
a fourth workstation downstream from the third workstation including a partial edge sealer; and
a fifth workstation downstream from the fourth workstation from which a completed insulated glass unit can be removed.

11. The robotic work cell to manufacture insulated glass units as claimed in claim 8, wherein the robot is programmed to robotically return the first glass lite and applied spacer material to the first workstation and mate the first glass lite and applied spacer material to the second glass lite thus creating the at least partially primary sealed insulated glass unit.

12. The robotic work cell to manufacture insulated glass units as claimed in claim 8, further comprising a gas press downstream from the third workstation configured to fill a partially completed insulated glass unit with a non-air gas.

13. A robotic work cell to manufacture insulated glass units, comprising:
a series of manufacturing stations arranged in a U shape having three sides;
a first workstation structured to receive glass lites placed manually by an operator; and
a last workstation structured to receive completed insulated glass units to be removed manually by an operator;
wherein the first workstation and the last workstation are located in close proximity to each other at opposite ends of the U shape; and
a robot is located within reach of at least a portion of each of the three sides.

14. The robotic work cell to manufacture insulated glass units as claimed in claim 13, further comprising:
a robotic gripper supported by a robot positioned and structured to lift a first glass lite from the first workstation by applying a robotic gripper to a first surface of the first glass lite;
a second workstation including a spacer material applicator structured to apply spacer material to a perimeter of the supported first glass lite presented to the second workstation supported by the robotic gripper;
a third workstation reachable by the robot including a second conveyor; and
the third workstations comprising an edge sealant applicator;
wherein the first workstation, the second workstation and the third workstation are within reach of the robotic gripper as manipulated by the robot while a base of the robot is stationary.

15. The robotic work cell to manufacture insulated glass units as claimed in claim 14, further comprising:
a first conveyor structured to receive and convey the first glass lite; and
the first workstation being downstream of the first conveyor and structured to receive the first glass lite conveyed and a second glass lite from the first conveyor.

16. The robotic work cell to manufacture insulated glass units as claimed in claim 14, further comprising:
wherein the third workstation is reachable by the robot and includes a second conveyor; and further comprising:
a fourth workstation downstream from the third workstation including a partial edge sealer; and
a fifth workstation downstream from the fourth workstation from which a completed insulated glass unit can be removed.

17. The robotic work cell to manufacture insulated glass units as claimed in claim 14, wherein the robot is programmed to robotically return the first glass lite and applied spacer material to the first workstation and mate the first glass lite and applied spacer material to the second glass lite thus creating an at least partially primary sealed insulated glass unit.

18. The robotic work cell to manufacture insulated glass units as claimed in claim 14, further comprising a gas press downstream from the third workstation configured to fill a partially completed insulated glass unit with a non-air gas.
